(19) United States
(12) Patent Application Publication
(10) Pub. No.: US 2015/0051951 A1
(43) Pub. Date: Feb. 19, 2015

(54) SYSTEMS AND METHODS FOR ANALYZING ONLINE SURVEYS AND SURVEY CREATORS

(71) Applicant: SurveyMonkey Inc., Palo Alto, CA (US)

(72) Inventors: Tim G. Cederman-Haysom, San Carlos, CA (US); Douglas S. Morgan, San Jose, CA (US); Michael R. Sela, San Francisco, CA (US); Phillip J. Ludwig, San Francisco, CA (US)

(73) Assignee: SurveyMonkey Inc., Palo Alto, CA (US)

(21) Appl. No.: 13/966,829

(22) Filed: Aug. 14, 2013

(51) Int. Cl. G06Q 30/02

(52) U.S. Cl. CPC G06Q 30/0203
USPC 705/7.32

(57) ABSTRACT

A system can include a question repository to store multiple sets of questions, each set of questions including questions that may have a superficial, semantic, or open-ended modifier portion. A survey management module can allow a user to select a set of questions from the question repository for an online survey. A benchmarking module can group questions by semantic modifier options and provide an analysis based on information about the survey-creator and other survey-creators.

### TECHNICAL FIELD

The technical field pertains generally to systems and methods for administering and managing online surveys and, more particularly, to creating, facilitating, and evaluating such surveys by way of electronic devices such as personal computers and mobile electronic devices, e.g., smartphones and tablet computing devices.

### BACKGROUND

Online surveys have become increasingly valuable to individuals, companies, and virtually all types of organizations by enabling such entities to quickly and efficiently obtain various types of information from any number of target populations. Such information may include customer preferences, feedback on products and/or services, and customer service-related information. Companies may incorporate such information in making various business and/or strategic or otherwise tactical decisions, for example. Also, the continued prevalence of mobile electronic devices, such as smartphones and tablet devices, in today's society provides individuals and groups with even greater access to virtually every type of target populations for electronic surveys and other information-gathering mechanisms. Indeed, millions of people use the Internet or other networks on a regular—often daily—basis, both at home and at their workplace. Accordingly, there remains a need for further improvements in facilitating the administering and management of—and collecting information and data in association with—online surveys.

### SUMMARY

Embodiments of the disclosed technology generally pertain to systems and methods for managing online surveys and evaluating results thereof. In certain embodiments, an online survey is created based on a set of questions retrieved from a repository of questions. Once created, the survey is administered to a population. The population may be a targeted group of individuals or open to the public. Data and information collected from the creator of the survey may be evaluated as well. A benchmarking module may be used to make comparisons based on information from the creator of the survey and information from other creators of other, previously-generated or concurrently-created surveys. The comparing may also be based at least in part on semantic modifier portions of questions in the survey.

### BRIEF DESCRIPTION OF THE DRAWINGS

FIG. 1 illustrates an example of a networked system in accordance with certain embodiments of the disclosed technology.

FIG. 2 illustrates an example of an electronic device in which certain aspects of various embodiments of the disclosed technology may be implemented.

FIG. 3 is a flowchart illustrating an example of a computer-controlled method in accordance with certain embodiments of the disclosed technology.

FIG. 4 illustrates an example of a first user interaction with a user interface in accordance with certain embodiments of the disclosed technology.

FIG. 5 illustrates an example of a second user interaction with the user interface of FIG. 4 in accordance with certain embodiments of the disclosed technology.

FIG. 6 illustrates an example of a third user interaction with the user interface of FIGS. 4 and 5 in accordance with certain embodiments of the disclosed technology.

FIG. 7 illustrates an example of an online survey management and survey result evaluation system in accordance with certain embodiments of the disclosed technology.

### DETAILED DESCRIPTION

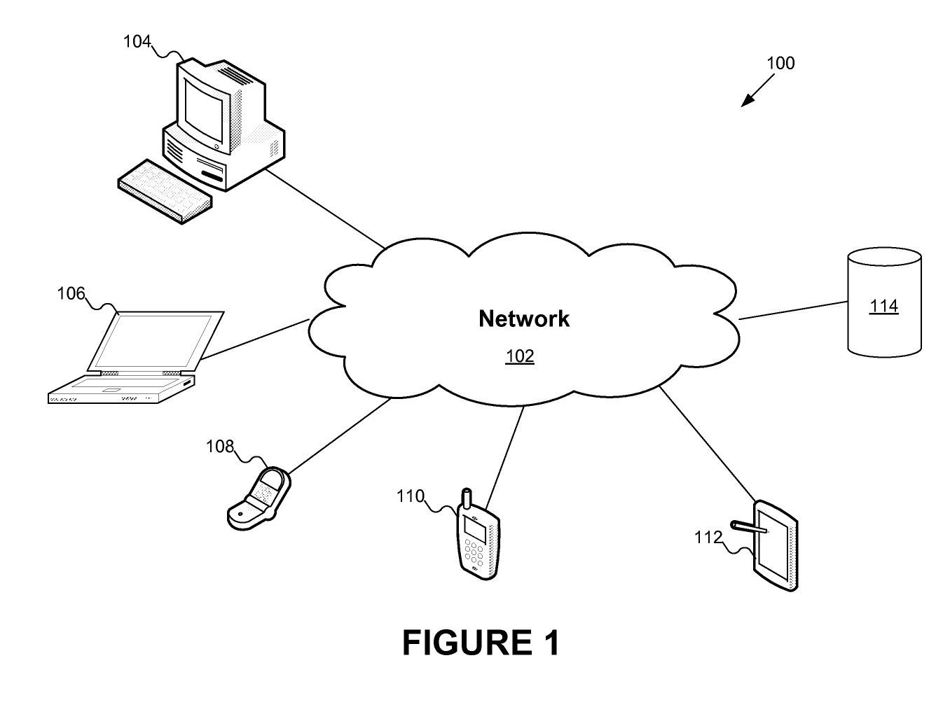

FIG. 1 illustrates an example of a networked system 100 in accordance with certain embodiments of the disclosed technology. In the example, the system 100 includes a network 102 such as the Internet, an intranet, a home network, a public network, or any other network suitable for implementing embodiments of the disclosed technology. In the example, personal computers 104 and 106 may connect to the network 102 to communicate with each other or with other devices connected to the network.

The system 100 also includes three mobile electronic devices 108-112. Two of the mobile electronic devices 108 and 110 are communications devices such as cellular telephones or smartphones. Another of the mobile devices 112 is a handheld computing device such as a personal digital assistant (PDA), tablet device, or other portable device. A storage device 114 may store some of all of the data that is accessed or otherwise used by any or all of the computers 104 and 106 and mobile electronic devices 108-112. The storage device 114 may be local or remote with regard to any or all of the computers 104 and 106 and mobile electronic devices 108-112.

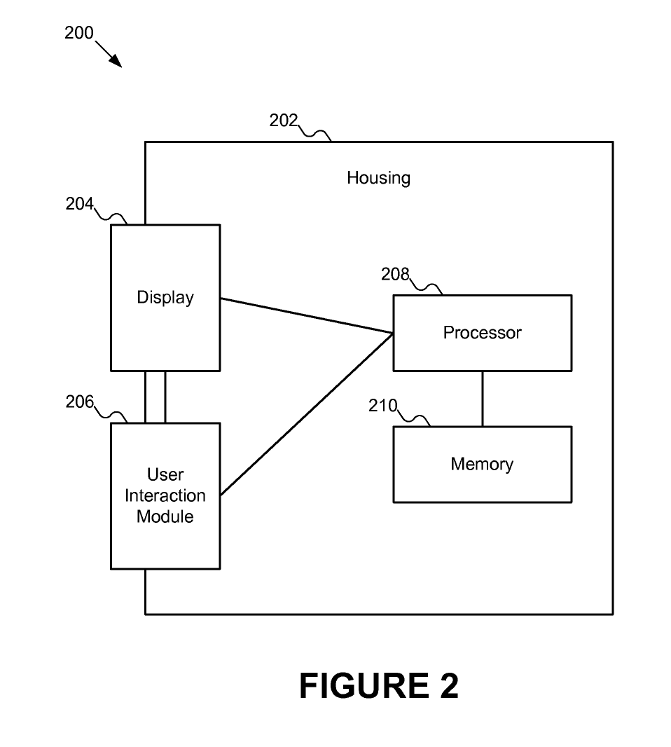

FIG. 2 illustrates an example of an electronic device 200, such as the devices 104-112 of the networked system 100 of FIG. 1, in which certain aspects of various embodiments of the disclosed technology may be implemented. The electronic device 200 may include, but is not limited to, a personal computing device such as a desktop or laptop computer, a mobile electronic device such as a PDA or tablet computing device, a mobile communications device such as a smartphone, an industry-specific machine such as a self-service kiosk or automated teller machine (ATM), or any other electronic device suitable for use in connection with certain embodiments of the disclosed technology.

In the example, the electronic device 200 includes a housing 202, a display 204 in association with the housing 202, a user interaction module 206 in association with the housing 202, a processor 208, and a memory 210. The user interaction module 206 may include a physical device, such as a keyboard, mouse, microphone, speaking, or any combination thereof, or a virtual device, such as a virtual keypad implemented within a touchscreen. The processor 208 may perform any of a number of various operations. The memory 210 may store information used by or resulting from processing performed by the processor 208.

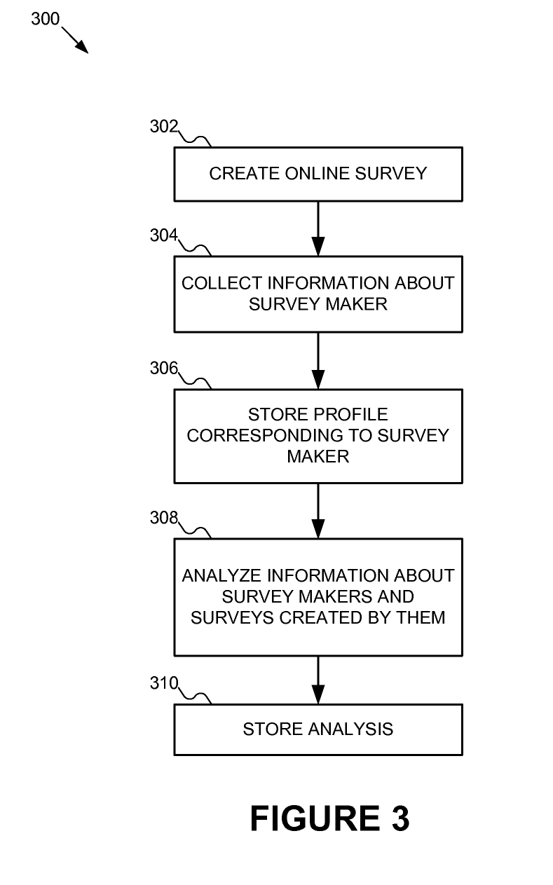

FIG. 3 is a flowchart illustrating an example of a computer-controlled method 300 in accordance with certain embodiments of the disclosed technology. At 302, an online survey is created. For example, a user may create a survey by accessing a question repository (also referred to herein as a question bank) that stores various sets of questions, some of which have superficial modifier portions, some of which have semantic modifier portions, and some of which have open-ended modifier portions. Some of the questions may have multiple types of modifier portions. In certain embodiments, a user may select a previously created survey.

As used herein, superficial modifiers generally pertain to any type of superficial change that does not alter the substance, or semantic meaning, of the question. An example of a superficial modifier is changing “he” to “she” in a question whose answer is wholly unrelated to gender. Semantic modifiers, as used herein, generally pertain to data fields or descriptions that are more than superficial, such as how somebody might feel about a certain type of object or thing, e.g., whether he or she likes or dislikes a certain product or service or otherwise loves or hates the product/service. Open-ended modifiers, as used herein, generally pertain to data fields or descriptions that can be provided directly by the creator of the question or survey. An example of an open-ended modifier is a dropdown box having a listing of job titles and a blank space in which the survey-creator can type a title that is not in the list, or type a person's name.

At 304, information about the survey-creator is collected. Such information may be stored in a profile corresponding to the user, as indicated at 306. In certain embodiments, a profile may be created for each survey-creator and updated accordingly after the creation of each additional survey by the corresponding survey-creator.

At 308, the online survey is analyzed or otherwise processed. For example, the system may compare information about the survey and survey-creator to other survey-generating individuals or groups and surveys that were previously and/or concurrently generated by such entities. A benchmarking feature as described here may be used to visually display or otherwise present to a user such comparisons.

At 310, results of the analysis may be optionally stored. The results may be stored locally, e.g., by the user's device, remotely such as by an external server, or both. In certain embodiments, each analysis may be named or otherwise identified based on the analysis for easy and efficient cataloging and subsequent access.

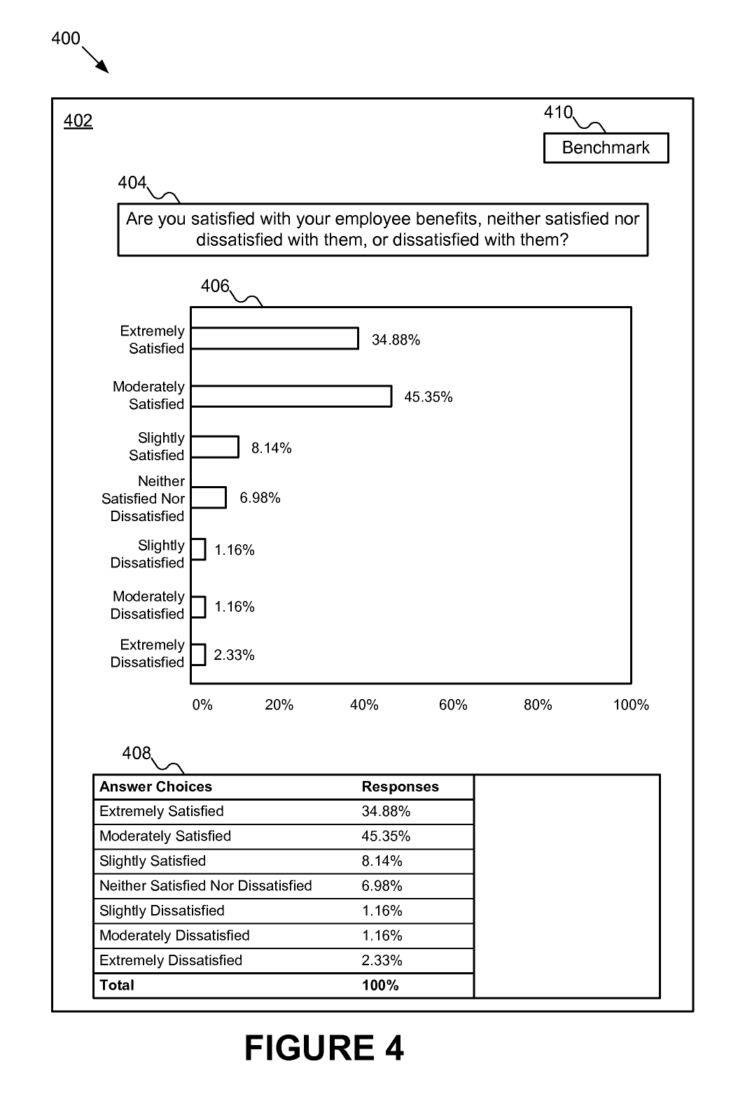

FIG. 4 illustrates an example of a first user interaction 400 with a user interface 402 in accordance with certain embodiments of the disclosed technology. The user interface 402, which may be provided or otherwise managed by a module such as the user interaction module 206 of FIG. 2, includes a question portion 404 that visually presents a representation of at least one question having corresponding superficial modifiers, semantic modifiers, open-ended modifiers, a combination thereof, or no modifiers at all. In the example, the question pertains to whether the survey-taker is satisfied with his or her employee benefits.

A bar graph portion 406 of the user interface 402 provides the user with a visual representation of information about the survey based on previously-generated surveys by other survey-creators that asked the same semantic question. In the example, the bar graph portion 406 provides a visual indication as to what percentage of survey-takers answered each of the seven possible responses to the originally-presented question as indicated by the question portion 404. It should be noted that, while the results that are visually presented in the illustrated example are presented by way of bar graphs and expressed percentages, any of a number of other suitable techniques may be used to present the results to the user or other viewer.

A table portion 408 of the user interface 402 provides an alternative displaying of the responses to the question as indicated by the question portion 404. In the example, the table portion 408 includes a table that lists the possible responses to the question in a first column and an indication as to what percentage of survey-makers selected each of the possible responses. In certain embodiments, either or both of the display portions 406 and 408 may include an indication as to how many survey-takers selected each of the possible responses, how many survey-creators there were that asked the same semantic question in total, or both. Alternatively or in addition thereto, such information may be presented elsewhere within or in connection with the user interface 402.

A benchmarking button 410, when selected by the user, may cause the system to enable a benchmarking feature as described herein.

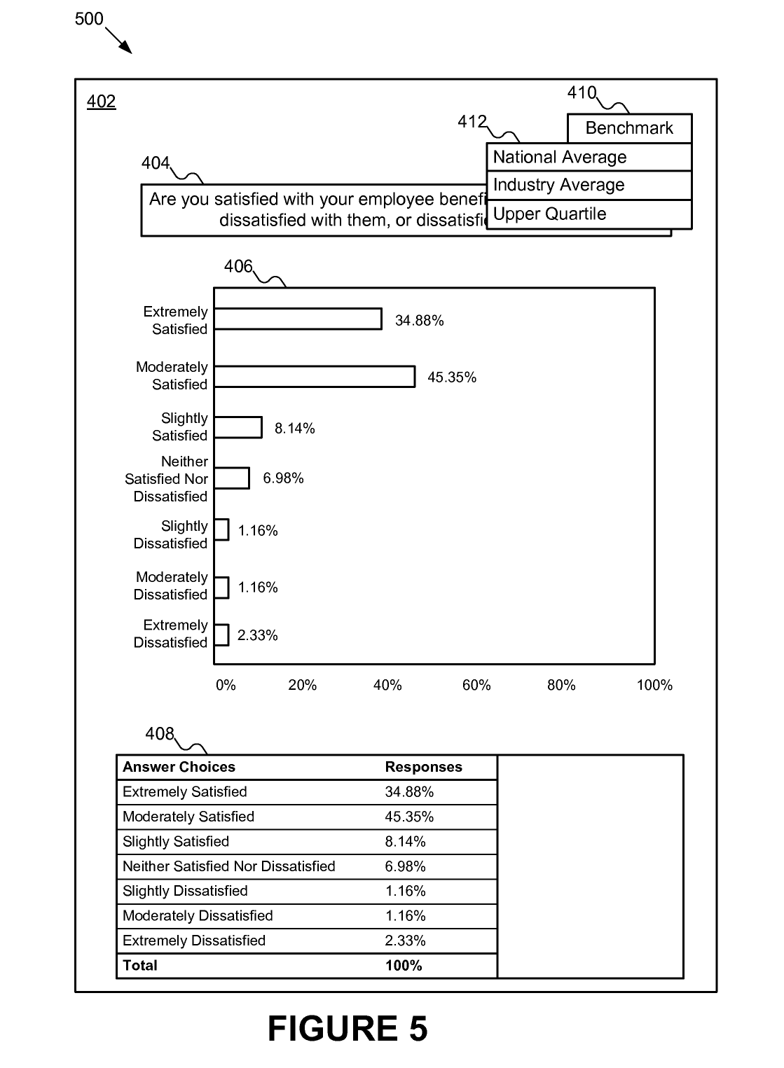

FIG. 5 illustrates an example of a second user interaction 500 with the user interface 402 of FIG. 4 in accordance with certain embodiments of the disclosed technology. In the example, the user has selected the benchmarking button 410. Responsive thereto, the user interface 402 provides the user with one or more selections 412 that each pertain to the benchmarking feature. In the example, the selections 412 include national average, industry average, and upper quartile. It should be noted, however, that other selections may be made available in addition to—or in place of—any of the options in the illustrated example.

The user may select a desired one of the selections 412 and, responsive thereto, the system may enable a feature corresponding to the selected option. Responsive to the user selection “National Average,” for example, the system may provide a comparison of the currently-presented survey to those of survey-creators that asked the same semantic question nationwide. Responsive to the user selection “Industry Average,” however, the system may provide a comparison of the currently-presented survey to those of average answers to semantically identical questions asked by survey-creators that are within a certain industry, e.g., the same industry as the survey-creator(s) whose results are currently presented by the user interface 403.

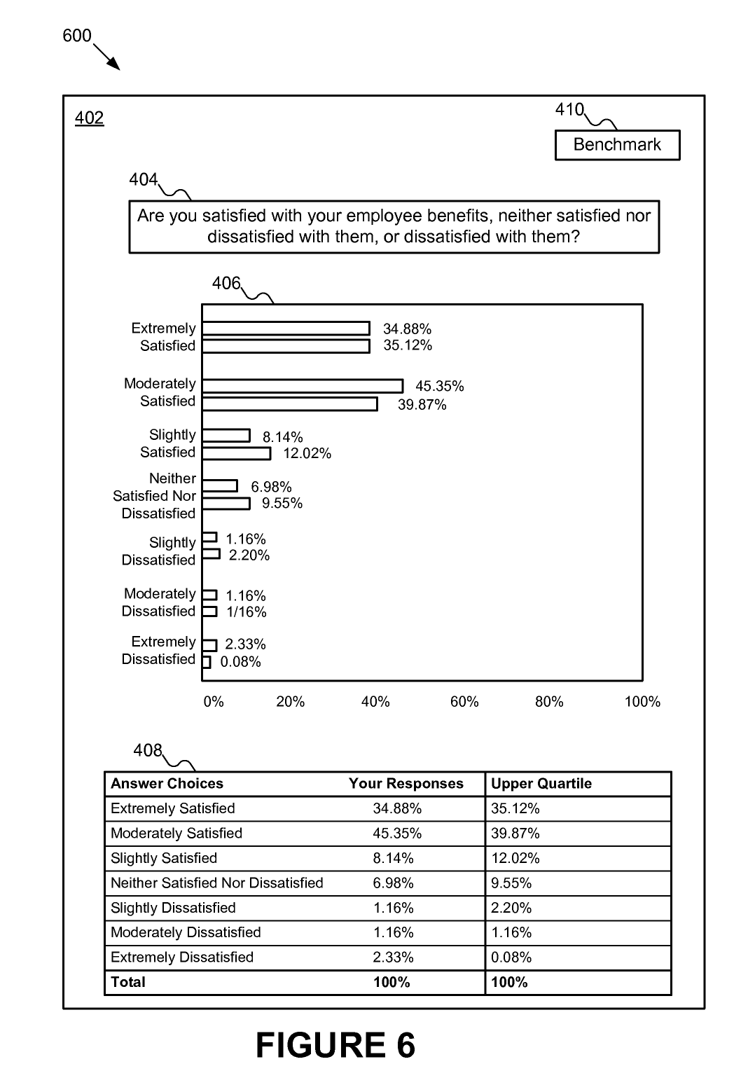

FIG. 6 illustrates an example of a third user interaction 600 with the user interface 402 of FIGS. 4 and 5 in accordance with certain embodiments of the disclosed technology. In the example, the user has selected “Upper Quartile” from the benchmarking button 410 in FIG. 5. The bar graph portion 406 and table portion 408 now provide a visual comparison of the already-presented results to those of the survey-creators that are or otherwise have been previously determined to represent the upper quartile of all of the survey-creators and have asked the same semantic question.

The entirety of survey-creators may be determined on the basis of modifiers, such as superficial modifiers, semantic modifiers, and/or open-ended modifiers, within the corresponding questions. For example, questions from other surveys that are similar—but not identical—to other questions may be included for purposes of the analysis as long as the question has not been semantically altered. The total pool of responses and associated information may be adjusted as surveys are added, removed, or altered. Such adjusting may happen responsive to a user request, at certain intervals, or real-time as survey changes occur.

In certain embodiments, a visual key (not shown) such as a certain color, pattern, or icon may be displayed to allow the user or other viewers to more quickly identify correlations between information presented in the bar graph portion 406 and information presented in the table portion 408.

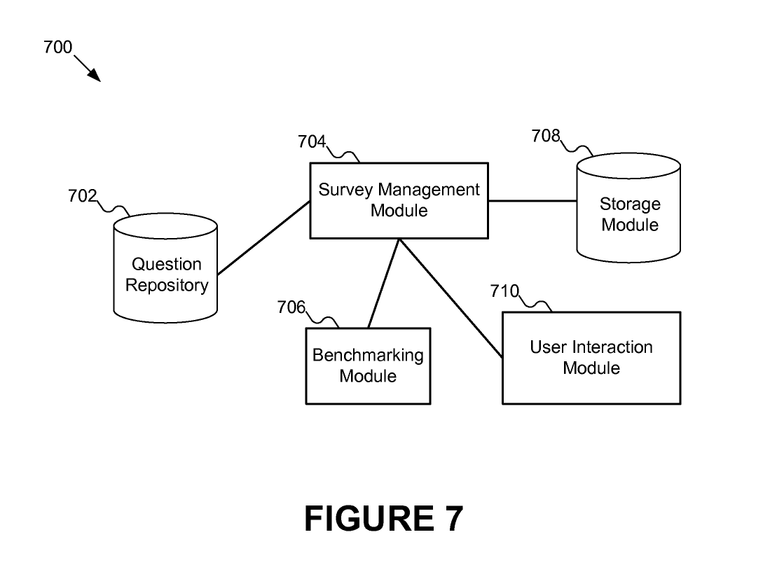

FIG. 7 illustrates an example of an online survey management and survey result evaluation system 700 in accordance with certain embodiments of the disclosed technology. In the example, the system 700 includes a question repository 702, also referred to herein as a question bank, that is configured to store multiple sets of questions, each set of questions including questions that have a superficial modifier portion, a semantic modifier portion, an open-ended modifier portion, or a combination thereof.

A survey management module 704 allows a user to select a set of questions from the question repository 702 for use as or otherwise with an online survey. The survey management module 704 may also provide semantic modifier options for each question having a semantic modifier portion.

A benchmarking module 706 may group questions and surveys by semantic modifiers and provide an analysis of the survey questions based on properties of the survey-creator and other, previously-created surveys by other survey-creators with different or similar properties as described herein.

A storage module 708 may be used to store results of the analysis. A user interaction module 710 may be used to control a user interface, such as the user interface 402 of FIGS. 4-6, that provides a visual representation of results of the analysis. The user interaction module 710 may also adjust the visual representation of the results based on the user adjusting or otherwise altering the analysis. In such embodiments, the storage module 708 may also store the altered analysis or results thereof. In certain embodiments, a parsing module (not shown) may be used to identify semantic modifier portions within the selected set of questions.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system, comprising:
a question repository configured to store multiple sets of questions, each set of questions including questions that have a superficial modifier portion, a semantic modifier portion, an open-ended modifier portion, or a combination thereof;
a survey management module configured to allow a user to select a set of questions from the question repository for an online survey, wherein the survey management module is further configured to provide superficial modifier, semantic modifier, and open-ended modifier options for each question having such modifier portions; and
a benchmarking module configured to collect information about the survey-creator, group the questions by semantic modifier options, and provide an analysis based on the collected information and information about other survey-creators that created other surveys with a question having the same semantic modifier options.

2. The system of claim 1, further comprising a storage module configured to store results of the analysis.

3. The system of claim 1, further comprising a user interaction module configured to control a user interface that provides a visual representation of results of the analysis.

4. The system of claim 3, wherein the visual representation includes a bar graph portion, a table portion, or both.

5. The system of claim 3, wherein the user interaction module is further configured to allow a user to alter the analysis.

6. The system of claim 5, wherein the user interaction module is further configured to alter the visual representation based on the altering of the analysis.

7. The system of claim 6, further comprising a storage module configured to store results of the altered analysis.

8. The system of claim 5, wherein the user interaction module alters the visual representation responsive to the user making a benchmarking selection.

9. The system of claim 8, wherein the benchmarking selection identifies a certain group of survey creators to be included in the altered analysis.

10. The system of claim 1, further comprising a parsing module configured to identify the semantic modifier portions within the selected set of questions.

11. The system of claim 10, wherein the parsing module is further configured to identify open-ended modifier portions within the selected set of questions.

12. A computer-controlled method, comprising:
a user creating an online survey, the online survey including a set of questions from a question repository, each question having a superficial modifier portion, a semantic modifier portion, an open-ended portion, or a combination thereof;
collecting information about the user;
collecting information about other users that have created other surveys including questions that have a superficial modifier portion, a semantic modifier portion, an open-ended portion, or a combination thereof;
grouping questions based on the semantic modifier portions of the questions in the surveys;
providing an analysis based on the online survey, the information about the user, the other surveys, and the information about the other users; and
providing a visual representation of the analysis.

13. The computer -controlled method of claim 12, wherein creating the online survey includes the user selecting a set of questions from a question repository.

14. The computer -controlled method of claim 12, further comprising storing the analysis.

15. The computer -controlled method of claim 12, further comprising receiving from a user a benchmarking selection.

16. The computer -controlled method of claim 15, further comprising altering the analysis based on the benchmarking selection.

17. The computer -controlled method of claim 16, further comprising adjusting the visual representation based on the altered analysis.

18. The computer -controlled method of claim 16, further comprising further comprising storing the altered analysis.

19. The computer -controlled method of claim 12, further comprising further comprising storing a user profile corresponding to the user.
